(19) United States
(12) Patent Application Publication
(10) Pub. No.: US 2025/0300734 A1
(43) Pub. Date: Sep. 25, 2025

(54) OPTICAL COMMUNICATION SYSTEM

(71) Applicant: DASAN Network Solutions, Inc., Seongnam-si (KR)

(72) Inventor: Sang Cheol MUN, Yongin-si (KR)

(73) Assignee: DASAN Network Solutions, Inc., Seongnam-si (KR)

(21) Appl. No.: 18/613,200

(22) Filed: Mar. 22, 2024

(51) Int. Cl. H04B 10/40

(52) U.S. Cl. CPC H04B 10/40

(57) ABSTRACT

Provided is an optical communication system including a multi-channel light source device configured to provide light source signals of N channels by splitting a non-modulated light signal with a first carrier wavelength of one laser diode (LD) into N channels and an optical communication device including a light signal receiver configured to photoelectrically convert a reception light signal received from an external light signal interface device through an optical fiber and transmit the converted signal to a communication signal processor and a light signal transmitter configured to modulate a data signal received from the communication signal processor into transmission light signals of N channels using the light source signals of N channels received from the external multi-channel light source device and transmit the modulated transmission light signals of N channels to the external light signal interface device through optical fibers.

### BACKGROUND

### 1. Field

The following description relates to an optical communication technology, and more particularly, to a technology in which a multichannel light source device for externally providing a light source signal to an optical communication device provides light source signals by splitting light signals of fewer laser diodes (LDs) than there are channels.

### 2. Description of Related Art

Optical communication systems employing optical fibers are most widely used in the field of wired communication. In general, an optical communication system employs an optical transceiver, which includes an optical transmitting module and an optical receiving module. The optical transmitting module may include an optical source and light modulator.

Since an optical transceiver is inserted into a port which is formed in the front panel of an optical communication device, such as a switch or the like, and used, a data signal which is photoelectrically converted at the optical transceiver is transmitted to an application-specific integrated circuit (ASIC) chipset for processing a data signal through a printed circuit board (PCB). With an increase in the processing capacity of an optical communication device, the number of ports into which optical transceivers are inserted increases, which complicates the connection between the ASIC chipset and the ports through the PCB.

In an optical communication system employing optical fibers as transmission lines, a laser diode (LD) is used as an optical source for an optical communication network. LDs can output high-power high-quality light, which makes LDs an advantageous light source for long-distance high-capacity light signal transmission. However, the operating characteristics of LDs are sensitive to ambient temperature, and a thermoelectric cooler (TEC) is required for stable operation.

Due to these problems, methods of positioning an LD in an external device and acquiring a light source signal from the external device are emerging. Here, these external light signal devices employ a separate LD for each channel, which still increases temperature and cost.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an optical communication system that employs a multi-channel light source device that splits a light signal with a carrier wavelength output by a laser diode (LD) into multiple channels.

Technical objects to be achieved in the present invention are not limited to those described above, and other technical objects that have not been described will be clearly understood by those of ordinary skill in the art from the following description.

In one general aspect, an optical communication system includes a multi-channel light source device and an optical communication device.

The multi-channel light source device provides light source signals of N channels by splitting a non-modulated light signal with a first carrier wavelength of one LD into N channels.

The optical communication device includes a light signal receiver and a light signal transmitter, the light signal receiver photoelectrically converts a reception light signal received from an external light signal interface device through an optical fiber and transmits the converted signal to a communication signal processor, and the light signal transmitter modulates a data signal received from the communication signal processor into transmission light signals of N channels using the light source signals of N channels received from the external multi-channel light source device and transmits the modulated transmission light signals of N channels to the external light signal interface device through optical fibers.

The multi-channel light source device may provide the light source signals of N channels by splitting non-modulated light signals with different carrier wavelengths output from two LDs into N/2 channels.

The multi-channel light source device may provide the light source signals of N channels by splitting non-modulated light signals with different carrier wavelengths output from four LDs into N/4 channels.

Other features and aspects will be apparent from the following detailed description, the drawings, and the claims.

### BRIEF DESCRIPTION OF THE DRAWINGS

FIG. 1 is an exemplary diagram illustrating an optical communication system employing a multi-channel light source device in which a laser diode (LD) is used as an optical source per channel in contrast with the present invention.

FIG. 2 is an exemplary diagram illustrating an optical communication system according to a first aspect of the present invention.

FIG. 3A is a conceptual diagram of a signal transmission path in an optical communication device of the related art.

FIG. 3B is a conceptual diagram of a signal transmission path in an optical communication device of the present invention.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It will be understood that elements of each of the embodiments may be combined in various ways within one embodiment unless otherwise stated or contradicted by one another. Each block in a block diagram may be a representation of a physical part in some cases, but may be a logical representation of a portion of a function of one physical part or a function of a plurality of physical parts in other cases. In some cases, a block or entry of a portion of the block may be a set of program instructions. All or some of the blocks may be implemented as hardware, software, or a combination thereof.

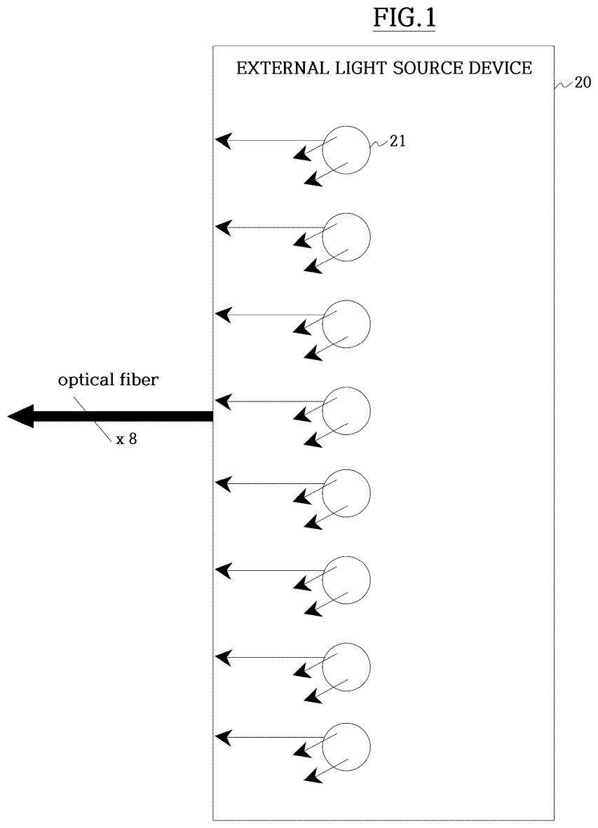

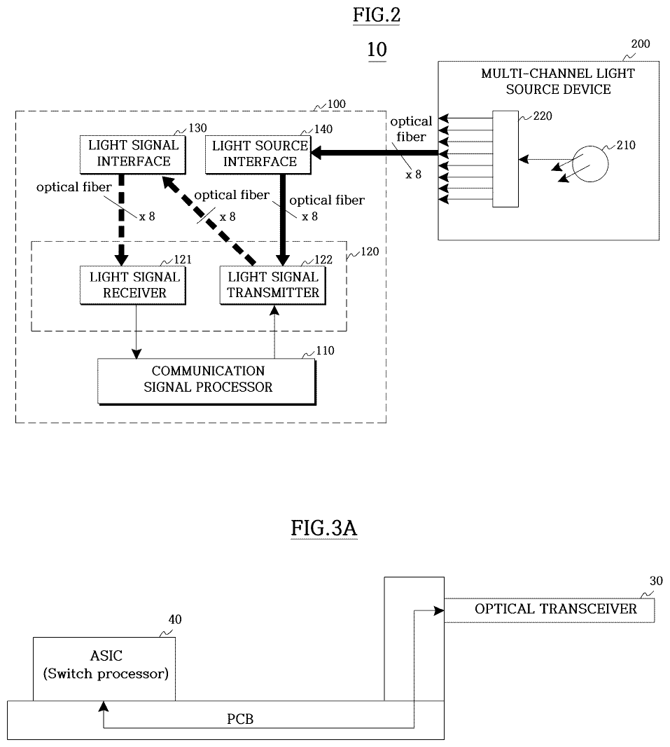

FIG. 1 is an exemplary diagram illustrating an optical communication system employing a multi-channel light source device in which a laser diode (LD) is used as an optical source per channel in contrast with the present invention.

An external light source device 20 of the related art shown in FIG. 1 is an example in which light source signals of eight channels are provided, and a separate LD 21 is used in each channel. Accordingly, the external light source device 20 shown in FIG. 1 includes eight LDs 21.

The LDs 21 are semiconductor devices that are similar to light-emitting diodes (LEDs), and output coherent light of which all waves have the same frequency and phase using a p-n junction.

The external light source device 20 of the related art shown in FIG. 1 employs several LDs as multiple light sources, which relatively increases power consumption and an amount of heat. Therefore, it is necessary to lower the operating temperature and power consumption of the external light source device 20.

The optical communication system 10 according to the first aspect of the present invention includes a multi-channel light source device 200 and an optical communication device 100.

The multi-channel light source device 200 according to the first aspect includes one LD 210 and an optical splitter 220.

The LD 210 outputs a non-modulated light signal with a first carrier wavelength. The wavelength band of the light signal output by the LD 210 may be appropriately determined according to a transmission rate and the like.

The optical splitter 220 outputs light source signals of N channels by splitting the light signal with the first carrier wavelength into N channels. The light source signals of N channels output by the multi-channel light source device 200 are used as light signals with the carrier wavelength when an optical modulation module connected through optical fibers performs modulation.

Here, the number of channels may be two, four, eight, or the like.

As an example, the multi-channel light source device 200 may output light source signals of eight channels with a single wavelength by splitting the light signal with the first carrier wavelength output by the LD 210 into eight channels.

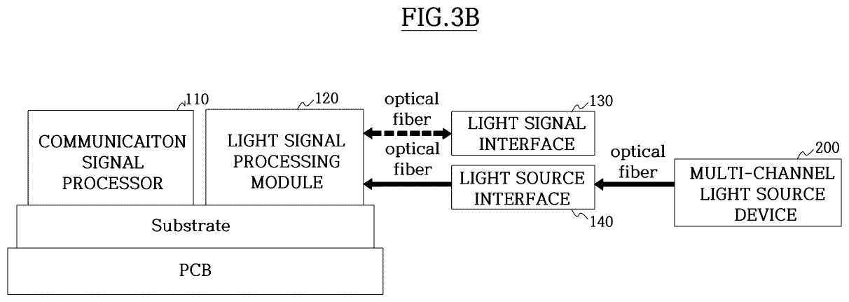

FIG. 3A is a conceptual diagram of a signal transmission path in an optical communication device of the related art, and FIG. 3B is a conceptual diagram of a signal transmission path in an optical communication device of the present invention.

An optical communication device 100 of the present invention may be a communication device such as a network switch, a router, or the like. As an optical communication device of the related art, an optical transceiver 30 is employed. The optical communication device of the related art photoelectrically converts a received light signal and then transmits the converted signal to a processor 40, such as an application-specific integrated circuit (ASIC) or the like, through a printed circuit board (PCB). On the other hand, the optical communication device 100 of the present invention employs no optical transceiver. In the optical communication device 100 of the present invention, a light signal of an optical cable inserted into a port (a light signal interface 130) in a front panel is transmitted to a light signal processing module 120 through an optical fiber, photoelectrically converted, and then transmitted through a substrate, on which the light signal processing module 120 and a communication signal processor 110 are mounted together, without passing through a main PCB.

The optical communication device 100 of the present invention includes a light signal receiver 121, a light signal transmitter 122, and the communication signal processor 110. The light signal receiver 121 and the light signal transmitter 122 constitute a part of the light signal processing module 120, and the communication signal processor 110 includes a network processor such as an ASIC or the like.

The light signal receiver 121 photoelectrically converts a reception light signal received from the external light signal interface device 130, which is the port formed in the front panel of the optical communication device 100, through the optical fiber and transmits the converted signal to the communication signal processor 110.

The light signal transmitter 122 outputs a transmission light signal by optically modulating a data signal received from the communication signal processor 110. Here, the light signal transmitter 122 receives light source signals of N channels to be used in optical modulation from an external light source interface 140, which is a port formed in the front panel, through an optical fiber. The light signal transmitter 122 modulates the data signal into transmission light signals of N channels using the light source signals of N channels received from the external multi-channel light source device 200 and transmits the modulated transmission light signals of N channels to the external light signal interface device 130 through optical fibers.

As an example, the light signal transmitter 122 of the present invention may receive output light source signals of eight channels with a single wavelength by splitting the light signal with the first carrier wavelength output by the LD 210 into eight channels.

A multi-channel light source device of the optical communication system 10 according to a second aspect of the present invention may provide light source signals of N channels by splitting non-modulated light signals with different carrier wavelengths output from two LDs into N/2 channels.

In other words, the multi-channel light source device according to the second aspect includes two LDs that output non-modulated light signals with different carrier wavelengths, and each of the LDs may split a light signal into N/2 channels through an internal optical splitter. For example, when the multi-channel light source device provides light source signals of eight channels, a light signal with a carrier wavelength of each LD is split into four channels.

A multi-channel light source device of the optical communication system 10 according to a third aspect of the present invention may provide light source signals of N channels by splitting non-modulated light signals with different carrier wavelengths output from four LDs into N/4 channels.

In other words, the multi-channel light source device according to the third aspect includes four LDs that output non-modulated light signals with different carrier wavelengths, and each of the LDs may split a light signal into N/4 channels through an internal optical splitter. For example, when the multi-channel light source device provides light source signals of eight channels, a light signal with a carrier wavelength of each LD is split into two channels.

The multi-channel light source device according to the second aspect and the multi-channel light source device according to the third aspect are different from the multi-channel light source device according to the first aspect in the number of LDs, the number of optical splitters, and the number of split channels, and thus will not be illustrated.

According to the proposed invention, it is possible to provide an optical communication system employing a multi-channel light source device which splits a light signal with a carrier wavelength output by an LD into multiple channels.

While the present invention has been described with reference to embodiments and the accompanying drawings, the present invention is not limited thereto. The present invention should be construed as encompassing various modifications that may be evidently derived from the embodiments by those of ordinary skill in the art. The claims are intended to include such modifications.

What is claimed is:

1. An optical communication system comprising:
a multi-channel light source device configured to provide light source signals of N channels by splitting a non-modulated light signal with a first carrier wavelength of one laser diode (LD) into N channels; and
an optical communication device comprising a light signal receiver configured to photoelectrically convert a reception light signal received from an external light signal interface device through an optical fiber and transmit the converted signal to a communication signal processor and a light signal transmitter configured to modulate a data signal received from the communication signal processor into transmission light signals of N channels using the light source signals of N channels received from the external multi-channel light source device and transmit the modulated transmission light signals of N channels to the external light signal interface device through optical fibers.

2. The optical communication system of claim 1, wherein the multi-channel light source device provides the light source signals of N channels by splitting non-modulated light signals with different carrier wavelengths output from two LDs into N/2 channels.

3. The optical communication system of claim 1, wherein the multi-channel light source device provides the light source signals of N channels by splitting non-modulated light signals with different carrier wavelengths output from four LDs into N/4 channels.
